(19) United States
(12) Patent Application Publication
(10) Pub. No.: US 2025/0338207 A1
(43) Pub. Date: Oct. 30, 2025

(54) METHOD AND SYSTEM FOR AN ENERGY CONSUMPTION CONTROL SERVICE

(71) Applicant: Verizon Patent and Licensing Inc., Basking Ridge, NJ (US)

(72) Inventors: Violeta Cakulev, Millburn, NJ (US); Lalit R. Kotecha, San Ramon, CA (US); Sudhakar Reddy Patil, Flower Mound, TX (US); Lixia Yan, Basking Ridge, NJ (US)

(21) Appl. No.: 18/645,731

(22) Filed: Apr. 25, 2024

(51) Int. Cl. H04W 52/02; H04W 4/50; H04W 8/18

(52) U.S. Cl. CPC H04W 52/0203; H04W 4/50; H04W 8/18

(57) ABSTRACT

A method, network device, system, and non-transitory computer-readable storage medium are described in relation to an energy consumption control service that includes receiving, from an end device, a registration request; retrieving, responsive to the registration request, subscription information including energy consumption control service criteria; selecting, using the energy consumption control service criteria, network components based on energy consumption profiles associated with the network components; and provisioning an application session for the end device according to the energy consumption control service criteria.

### BACKGROUND

Development and design of networks present certain challenges from a network-side perspective, including operational approaches to managing energy consumption by network components. For example, energy efficiency and energy savings are being defined for Next Generation (NG) wireless networks, such as Fifth Generation New Radio (5G NR) networks. Some proposed solutions to optimize energy consumption include adapting a radio access network (RAN) itself, e.g., activating and deactivating select portions of the RAN. However, the goal of energy use control as service criteria for supervising services in an energy-aware manner, with prescribed constraints and consequences-while ensuring the services are offered as intended-poses various technological challenges.

### BRIEF DESCRIPTION OF THE DRAWINGS

FIG. 1 is a diagram illustrating an exemplary environment in which an exemplary embodiment of an energy usage control service may be implemented;

FIG. 2 is a diagram illustrating exemplary components of a network device that provide an exemplary embodiment of the energy usage control service;

FIGS. 3A-3C are diagrams illustrating an exemplary communication flow of an exemplary embodiment of the energy usage control service according to an exemplary scenario;

FIG. 4 is a diagram illustrating exemplary components of a device that may correspond to one or more of the devices illustrated and described herein; and

FIG. 5 is a diagram illustrating an exemplary process of an exemplary embodiment of the energy usage control service.

### DETAILED DESCRIPTION

The following detailed description refers to the accompanying drawings. The same reference numbers in different drawings may identify the same or similar elements. Also, the following detailed description does not limit the invention.

Energy consumption is a significant source of operational cost for mobile network operators (MNOs). Controlling energy consumption in a network is beneficial in terms of reducing operational cost savings, lessening environmental impact, extending component life cycle, and the like. A number of functional requirements are identified that provide increased control over energy use to achieve service objectives for MNOs, service providers, and end users.

According to exemplary embodiments, an energy usage control service is described herein. The energy usage control service may be applied to a wireless environment. For example, the wireless environment may include a Fourth Generation (4G) wireless environment, a wireless local area network (WLAN), a 5G wireless environment, an evolved packet system (EPS)-5G core (5GC) interworking network, a 4G core network, a 5GC network, and/or a future generation wireless environment, as described herein.

According to various exemplary embodiments, the energy usage control service may be implemented to include a network device. For purposes of description, the network device may include an energy usage control function, as described herein. The network device may include functional elements that provide various sub-services of the energy usage control service, as described herein.

According to an exemplary embodiment, the energy usage control service may provide policy-based energy consumption services using network and policy-based application programming interfaces (APIs). The energy usage control service may provide a user (e.g., subscriber), or a third-party application function, the option to specify service plan (e.g., subscription) requirements that relate to various types of service criteria, as described herein. The energy usage control service may define, select, enforce, and/or update policies based on in-session information. For example, the in-session information may be used to update the subscriber's session in a network function (NF) selection procedure, a radio access technology (RAT)/frequency selection priority (RFSP) index selection procedure, or another service-level agreement (SLA)-based requirement.

In view of the foregoing, the energy usage control service may enable energy consumption control with respect to one or more components of a RAN, a 5GC, a multi-access edge computing (MEC) network, a network slice, and the like, during an application session, according to energy consumption profiles associated with the RAN, 5GC, MEC, and/or network slice components. The user may be incentivized and/or compensated with respect to the enabled energy consumption controls or measures, since application of the controls may result in degraded quality of service (QOS).

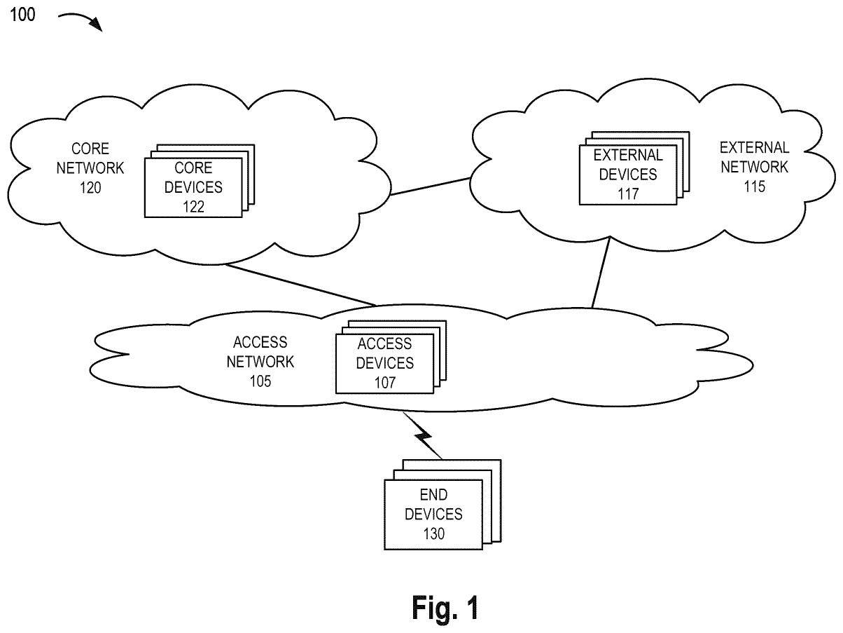

FIG. 1 is a diagram illustrating an exemplary environment 100 in which an exemplary embodiment of an energy usage control service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices or UE 130 (also referred to individually and generally as end device or UE 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the energy usage control service may use at least one of these planes of communication. Additionally, an interface of a network device may be modified (e.g., relative to an interface defined by a standards body, such as Third Generation Partnership Project (3GPP), 3GPP2, International Telecommunication Union (ITU), European Telecommunications Standards Institute (ETSI), Global System for Mobile Communications Association (GSMA), etc.) or a new interface of the network device may be provided in order to support the communication (e.g., transmission and reception of messages, information elements (IEs), attribute value pairs (AVPs), etc.) between network devices and the energy usage control service logic of the network device, as described herein. According to various exemplary implementations, the interface of the network device may be a service-based interface, a reference point-based interface, an Open Radio Access Network (O-RAN) interface, or some other type of interface.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, NSA, standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. According to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), Data-as-a-Service (DaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to an exemplary embodiment, at least some of external devices 117 may include logic of the energy usage control service. For example, an AS, a MEC server, an IP server, a cloud server, an Internet or Web server, a similar network device that may host an application service (also referred to simply as an AS), or another type of external device 117 (e.g., a management device associated with a farm or cluster of ASs, etc.) may provide an exemplary embodiment of the energy usage control service, as described herein.

Core network 120 may include one or multiple networks of one or multiple network types and technologies. Core network 120 may include a complementary network of access network 105. For example, core network 120 may be implemented to include a 5G core network, an EPC of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a PDN gateway (PGW), an enhanced packet data gateway (ePDG), a serving gateway (SGW), a home agent (HA), a General Packet Radio Service (GPRS) support node (GGSN), an HSS, an authentication, authorization, and accounting (AAA) server, a policy and charging rules function (PCRF), a policy and charging enforcement function (PCEF), and/or a charging function (CHF).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 may include logic of the energy usage control service. For example, one or multiple AFs may provide an exemplary embodiment of the energy usage control service, as described herein. The AF(s) may include functional elements that provide sub-services of the energy usage control service. For example, the AF(s) may include a storage device that may store end device profile information, a policy device that may store and create policies relating to an application and end device 130, as described herein. The AF(s) may include a controller or management device that may dynamically generate communication profiles for obtaining information from other network devices and systems of relevance to the policies associated with the user application and end device 130. The AF(s) may also include a collection and notification device(s) that may subscribe to notifications pertaining to end device location-triggered updates and other policy-related states associated with the application and end device 130, as well as providing such notifications to the subscribing device. For example, the subscribing device may be implemented as an AS or the like, which may host the user application of relevance to which end device 130 may use or access. The AF(s) is described further herein.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

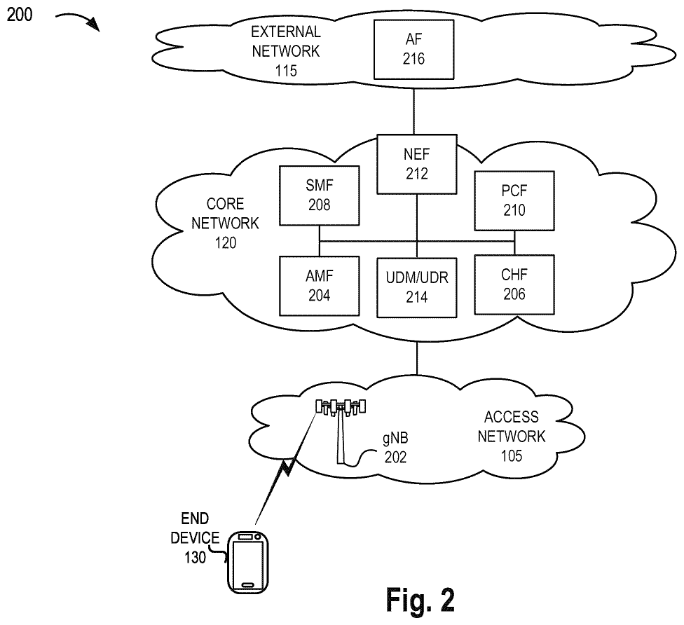

FIG. 2 is a diagram illustrating another exemplary environment in which an exemplary embodiment of the energy usage control service may be implemented. As illustrated, exemplary environment 200 may include a gNB 202, an AMF 204, a CHF 206, an SMF 208, a PCF 210, a NEF 212, a UDM/UDR 214, an AF 216, and end device 130. gNB 202 is an exemplary implementation of access device 107. AMF 204, UPF 206, SMF 208, PCF 210, NEF 212, and UDM/UDR 214 are exemplary implementations of core devices 122. AF 216 is an exemplary implementation of external device 117.

gNB 202, AMF 204, CHF 206, SMF 208, PCF 210, NEF 212, and/or UDM/UDR 214 may each provide a function and/or a service in accordance with a network standard, such as Third Generation Partnership Project (3GPP), 3GPP2, International Telecommunication Union (ITU), European Telecommunications Standards Institute (ETSI), GSM Association (GSMA), and the like and/or of a proprietary nature. For example, gNB 202 may include a radio node that enables end device 130 to connect with core network 120 using a 5G air interface. gNB 202 may provide user plane and control plane terminations towards end device 130. gNB 202 may include CU, DU, and RU functions that provide for mobility control, radio resource management (RRM), session management, packet processing, and physical and media access control (MAC) layer functionalities, among other functions.

AMF 204 may provide registration, connection, reachability, and mobility management, security context management, location service management, UE mobility event notification, among other functions. CHF 206 may provide policy counters pertaining to the subscriber's usage to PCF 210, provide notifications of a change in the policy counters, among other functions. PCF 210 may provide an external PDU session point of interconnect to external network 115 (e.g., a data network, etc.), provide packet routing and forwarding, packet inspection, user plane policy rule enforcement, traffic usage reporting, QoS handling for user plane, among other functions. SMF 208 may provide session management, Internet Protocol (IP) address allocation and management, selection, and control of user plane (UP) function, configuration of traffic steering, control of policy enforcement and QoS, among other functions. NEF 212 may provide secure exposure to services, capabilities, and resources over APIs within and outside of core network 120, perform packet filter description (PFD) management procedures, translate information and allow third party network devices to access core network devices and vice versa, among other functions. UDM/UDR 214 may provide authentication, access authorization based on subscription data, subscription management, support to service/session continuity, among other functions.

According to an exemplary embodiment, gNB 202, AMF 204, CHF 206, SMF 208, PCF 210, NEF 212, and UDM/UDR 214 may include logic of an exemplary embodiment of the energy usage control service and/or provide support for a process of the energy usage control service, as described herein.

AF 216 may host an application service that may be used by end device 130.

Environment 200 is exemplary and according to other embodiments, environment 200 may include additional, different, and/or fewer network devices. For example, according to other exemplary embodiments, access network 105, core network 120, and/or external network 115 may include another type of access device 107, core device 122, and/or external device 117 than those illustrated and described in relation to FIG. 2.

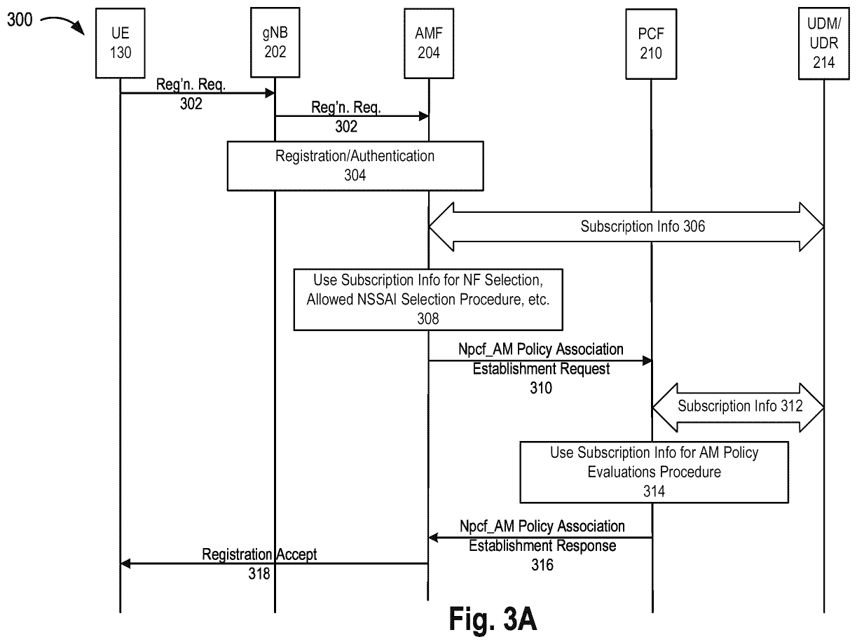

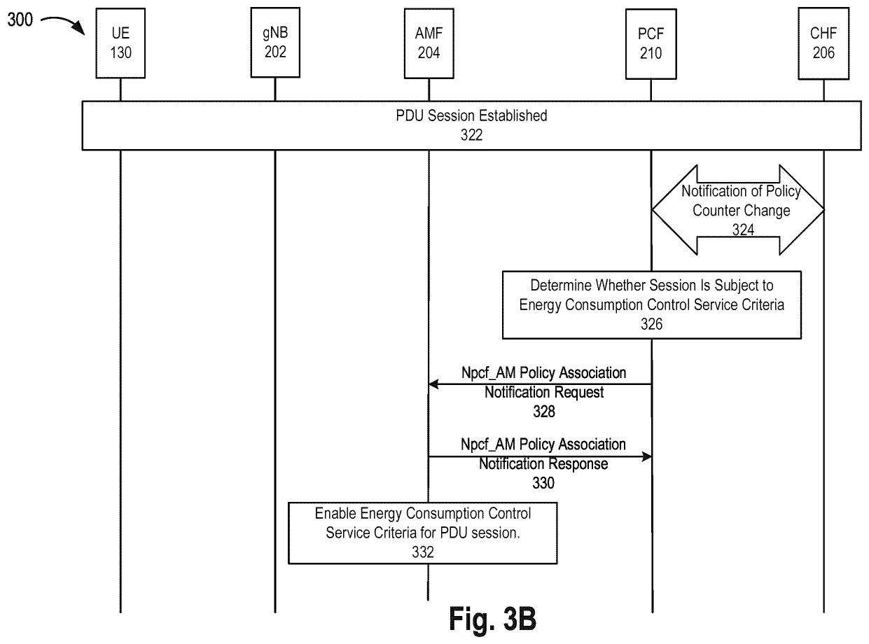

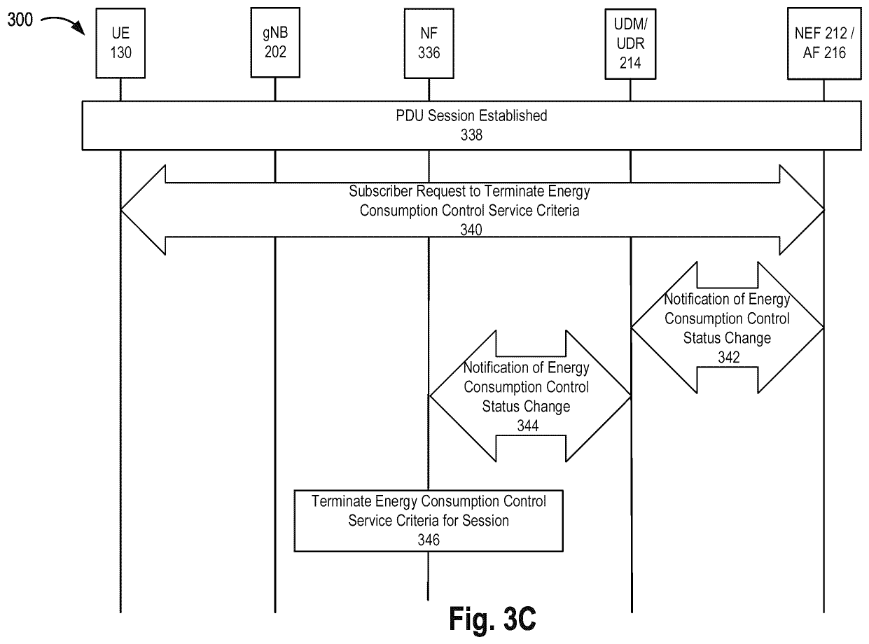

FIGS. 3A and 3B are diagrams illustrating an exemplary process 300 of an exemplary embodiment of the energy usage control service according to an exemplary scenario. For purposes of description, process 300 is described in relation to environment 200.

Referring to FIG. 3A, according to an exemplary scenario, UE 130 may generate and transmit a registration request 302 to gNB 202. Registration request 302 may pertain to end device 130 and/or a user associated with end device 130. Registration request 302 may include various types of information, which may include UE and/or user information.

gNB 202 may forward registration request 302 to AMF 204. Responsive to registration request 302, gNB 202 and/or AMF 204 may perform a registration/authentication procedure (block 304) for UE 130. Following registration and/or authentication, AMF 204 may receive, from UDM/UDR 214, subscription (e.g., service plan) information 306 for the user. Subscription information 306 may include energy consumption control data indicating whether the subscriber's sessions are subject to identified energy efficiency and/or energy savings policies. The energy consumption control data may include a “flag,” an IE, or other data indicating whether the user subscription includes energy consumption control service criteria.

AMF 204 may use the energy consumption control data for performing various procedures (block 308), such as using an energy consumption profile for selecting NFs for the subscriber's session, determining allowed slice networks for the subscriber's session, selecting a MEC network, determining QoS, and the like. AMF 204 may generate and forward an AM policy association establishment request message 310 to PCF 210. In response to the request, PCF 210 may request and receive subscription information 312 from UDM/UDR 214. In another example, UDM/UDR 214 may forward subscription information 306 to a UE PCF as part of the registration procedure. The subscription information may include energy consumption control data indicating whether the subscriber's sessions are subject to identified energy efficiency and/or energy savings policies.

PCF 210 may use the energy consumption control data to perform a procedure for evaluating AM policies (block 314). PCF 210 may generate and forward an AM policy association establishment response message 316 to AMF 204. In response, AMF 204 may generate and forward a registration accept message 318 to UE 130.

Referring to FIG. 3B, according to another exemplary implementation depicted in process 300, the subscriber associated with UE 130 is registered and authenticated, and a PDU session is established (block 322) in response to an application session request generated by UE 130. In this example, the current session status is that energy consumption controls are not being applied to the PDU session. Additionally, the session establishment procedures may have included UDM/UDR 214 forwarding the subscription information, including energy consumption control service criteria, to an SM PCF (not illustrated).

In this scenario, the MNO may dynamically change the status of the session in response to receiving a notification from an NF indicating a change in the PDU session from the network perspective. For example, CHF 206 may monitor and detect a change in subscriber usage of network resources, and in response may generate and forward a notification of policy counter change 324 to PCF 210. In response to the notification, PCF 210 may determine whether, based on the change, the session should be subject to energy consumption control service criteria 326.

Responsive to a determination that a status change is warranted, PCF 210 may generate and forward an AM policy association notification request 328 to AMF 204, to update the subscriber's policies and notify AMF 204 that energy consumption controls should be enabled. In response to the request, AMF 204 may generate and forward an AM policy association notification response 330 to PCF 210. AMF may enable the energy consumption control service criteria for the PDU session, for example, to perform NF selection, determine allowed network slice selection assistance information (NSSAIs), and/or provide SLA requirements (e.g., latency, packet loss, throughput or other performance metrics) for the PDU session. In one implementation, the service criteria may correlate to an energy consumption profile associated with the alternative network bearers and/or configurations.

Referring to FIG. 3C, according to another exemplary implementation depicted in process 300, the subscriber associated with UE 130 is registered and authenticated, and a PDU session is established (block 338) in response to an application session request generated by UE 130. In this example, the current session status is that energy consumption controls are configured for application to the PDU session. Additionally, the session establishment procedures may include UDM/UDR 214 forwarding the subscription information, including energy consumption control service criteria, to an SM PCF (not illustrated), where session management policies are evaluated based on the energy consumption control service criteria. Additionally, or alternatively, the UE registration procedures may include UDM/UDR 214 forwarding the subscription information, including energy consumption control service criteria, to a UE PCF (not illustrated), where UE route selection policy (URSP) rules are evaluated based on the energy consumption control service criteria.

In this scenario, the user may dynamically change the status of the session in response to input into an application on UE 130, for example indicating a change in the PDU session with respect to energy consumption control service criteria. For example, the subscriber may dynamically disable the energy consumption control service criteria on demand, before or during an application session, by generating and forwarding a notification 340 to AF 216. In response, AF 216 and/or NEF 212 may generate and forward a notification 342 to UDM/UDR 214 pertaining to the status change in energy consumption control. UDM/UDR 214 may generate and forward a notification of energy consumption control status change 344 to NF 336. NF 336 may accordingly discontinue or suspend energy consumption controls service criteria for subscriber's session (block 346). Termination of the energy consumption controls service criteria may trigger policy changes, slice reselection, NF reselection, and the like.

FIGS. 3A, 3B, and 3C illustrate process 300 according to an exemplary scenario, however according to other exemplary scenarios and/or embodiments, process 300 may include additional, different, and/or fewer steps or operations pertaining to the energy consumption control service, as described herein. For example, process 300 may include procedures in which energy efficiency/savings-related information included in the subscription information is provided to and subsequently used by SM PCF, UE PCF, etc. Additionally, or alternatively, the network-invoked status changed that is described with respect to policy counters from CHF 206, congestion information may be received from the NWDAF pertaining to the network slice currently being used, for example, as a basis for dynamically invoking energy efficiency/savings service criteria. Any network information generated internally or from a third party may be used as a basis for dynamically applying energy consumption controls per the subscription.

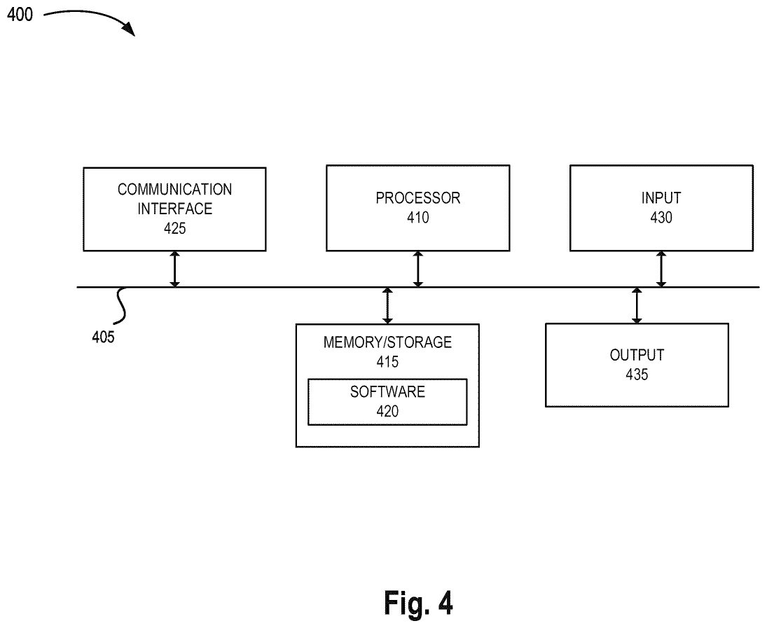

FIG. 4 is a diagram illustrating exemplary components of a device 400 that may be included in one or more of the devices described herein. For example, device 400 may correspond to access device 107, external device 117, core device 122, end device 130, network device 200, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to core device 122 (e.g., network device 200, etc.), software 420 may include an application that, when executed by processor 410, provides a function and/or a process of the energy usage control service, as described herein. Software 420 may also include firmware, middleware, microcode, hardware description language (HDL), and/or another form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, SaaS, DaaS, etc.). Device 400 may be implemented in the same manner. For example, device 400 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function, an operation, or a process described herein. Alternatively, for example, according to other implementations, device 400 may be configured to perform a function, an operation, or a process described herein based on the execution of hardware (processor 410, etc.).

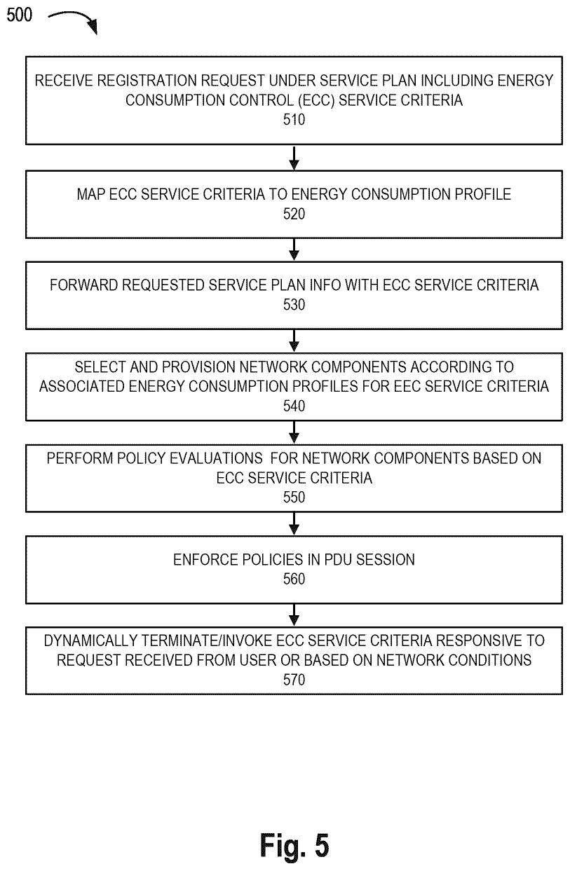

FIG. 5 is a flow diagram illustrating an exemplary process 500 of an exemplary embodiment of the energy consumption control service. According to an exemplary embodiment, one or more core devices 122 may perform operations of process 500. For example, an NF, such as a PCF, a UE PCF, an SM PCF, and/or AMF PCF may perform operations or steps of process 500. According to an exemplary implementation, processor 410 executes software 420 to perform a step (in whole or in part) of process 500, as described herein. Alternatively, a step (in whole or in part) may be performed by execution of only hardware. For purposes of description only, at least some of the operations of process 500 are described as being performed by the NF, without reference to a specific component of core network 120. Process 500 may include an operation illustrated and described in relation to FIGS. 3A-C, and elsewhere in the description.

In block 510, AMF 204 may receive a request for user registration associated with an individual UE 130 and/or any number of UEs 130, as described herein. For example, UE 130 may generate and transmit a registration request to gNB 202 under a service plan (e.g., subscription), which may identify energy consumption control service criteria, as described herein.

In block 520, a network device may perform a procedure to map the energy consumption control service criteria to a plurality of energy consumption profiles for various network configurations of network components (e.g., NFs 336) and network routes (e.g., network slices, data planes to MECs, etc.), as described herein. For example, energy consumption profiles may pertain to varying levels of energy savings and/or energy efficiencies identified for each set service criteria. The energy savings/efficiencies may define network performance requirements for the subscriber's sessions, as described herein.

In block 530, various network (e.g., 5GC) components may request, retrieve, and/or forward subscription information that includes that energy consumption control service criteria, as described herein. For example, subscription information stored in UDM/UDR 214 may be exchanged with PCF 210, AMF 204, UE 130, an SMF (not shown), as described herein. In block 540, the energy consumption profiles for energy consumption control service criteria may be used in a procedure for determining network configurations of network components (e.g., NFs 336) and network routes (e.g., slices, MECs, etc.) for a PDU session for UE 130.

In block 550, a network device may perform one or more policy evaluations pertaining to access and mobility management, as described herein. For example, PCF 210 may provide, responsive to a request from AMF 204, a response pertaining to access and mobility management policy association establishment, as described herein. In block 560, network devices may enforce the policies in a PDU session. For example, a data bearer may be established, and a session managed in accordance with the one or more policies.

In block 570, one or more network devices may dynamically terminate the energy consumption control service criteria, responsive to a request received from the user, as described herein. For example, the user of UE 130 may use an application interface to input an indication pertaining to suspending the energy consumption control service criteria for an application session, as described herein. The indication may identify a time period for reverting back to the previous subscribed—for network energy savings/efficiencies measures.

Additionally, or alternatively, the indication may provide for reverting back to the previous subscribed—for network energy savings/efficiencies measures when the current application session ends. According to another exemplary scenario in block 570, one or more network devices may dynamically invoke the energy consumption control service criteria, responsive to network conditions, as described herein. For example, a PCF (e.g., PCF 210) may determine that a subscriber's network usage, as indicate by policy counters received from a CHF (e.g., CHF 206), warrants activating energy savings/efficiencies measures according to energy consumption control service criteria defining same. The measures may remain in effect until a subscription billing cycle, for example, after which network resource usage is reset.

In one embodiment, energy consumption control service criteria may include multiple relative levels of energy efficiency and/or energy savings measures (e.g., low, medium, high, and/or first, second, third, etc.) which correspond to multiple relative levels of energy consumption profiles (e.g., low, medium, high, and/or first, second, third, etc.). The multiple levels may correspond to, for example, different levels of QoS and/or performance-based degradation.

FIG. 5 illustrates an exemplary process 500 of the energy usage control service, however, according to other exemplary embodiments, the energy usage control service may perform additional operations, fewer operations, and/or different operations than those illustrated and described in relation to FIG. 5.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the process illustrated in FIG. 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device from an end device, a registration request;
retrieving, by the network device responsive to the registration request, subscription information including energy consumption control service criteria;
selecting, by the network device and using the energy consumption control service criteria, network components based on energy consumption profiles associated with the network components; and
provisioning, by the network device, an application session for the end device according to the energy consumption control service criteria.

2. The method of claim 1, further comprising:
performing, using the energy consumption control service criteria, a procedure to determine allowed network slice selection assistance information (NSSAIs) for the application session.

3. The method of claim 1, further comprising:
receiving, via an application programming interface (API), an on-demand request from a subscriber associated with the end device, to suspend the energy consumption control service criteria during the application session.

4. The method of claim 1, further comprising:
dynamically invoking the energy consumption control service criteria based on information pertaining to network conditions.

5. The method of claim 1, further comprising:
dynamically invoking the energy consumption control service criteria based on policy counters related to the application session.

6. The method of claim 1, wherein provisioning the application session comprises imposing at least one of energy saving measures or energy efficiency measures on the application session.

7. The method of claim 1, further comprising:
evaluating, based on the energy consumption control service criteria, at least one of:
access mobility and management policies,
session management policies, or
user equipment (UE) route selection policy (URSP) rules.

8. A system comprising:
processors configured to:
receive, from an end device, a registration request;
retrieve, responsive to the registration request, subscription information including energy consumption control service criteria;
select, using the energy consumption control service criteria, network components based on energy consumption profiles associated with the network components; and
provision an application session for the end device according to the energy consumption control service criteria.

9. The system of claim 8, wherein the processors are further configured to:
perform, using the energy consumption control service criteria, a procedure to determine allowed network slice selection assistance information (NSSAIs) for the application session.

10. The system of claim 9, wherein the processors are further configured to:
receive, via an application programming interface (API), an on-demand request from a subscriber associated with the end device, to suspend the energy consumption control service criteria during the application session.

11. The system of claim 8, wherein the processors are further configured to:
dynamically invoke the energy consumption control service criteria based on information pertaining to network conditions.

12. The system of claim 8, wherein the processors are further configured to:
dynamically invoke the energy consumption control service criteria based on policy counters related to the application session.

13. The system of claim 8, wherein provisioning the application session comprises imposing at least one of energy saving measures or energy efficiency measures on the application session.

14. The system of claim 8, wherein the processors are further configured to:
evaluate, based on the energy consumption control service criteria, at least one of:
access mobility and management policies,
session management policies, or
user equipment (UE) route selection policy (URSP) rules.

15. A non-transitory computer-readable storage medium storing instructions executable by a processor of a network device, wherein the instructions are configured to:
receive, from an end device, a registration request;
retrieve, responsive to the registration request, subscription information including energy consumption control service criteria;
select, using the energy consumption control service criteria, network components based on energy consumption profiles associated with the network components; and
provision an application session for the end device according to the energy consumption control service criteria.

16. The non-transitory computer-readable storage medium of claim 15, wherein the instructions are further configured to:
receive, via an application programming interface (API), an on-demand request from a subscriber associated with the end device, to suspend the energy consumption control service criteria during the application session.

17. The non-transitory computer-readable storage medium of claim 16, wherein the instructions are further configured to:
dynamically invoke the energy consumption control service criteria based on information pertaining to network conditions.

18. The non-transitory computer-readable storage medium of claim 15, wherein the instructions are further configured to:
dynamically invoke the energy consumption control service criteria based on policy counters related to the application session.

19. The non-transitory computer-readable storage medium of claim 15, wherein the instructions to provision the application session are further configured to:
impose at least one of energy saving measures or energy efficiency measures on the application session.

20. The non-transitory computer-readable storage medium of claim 15, wherein the instructions are further configured to:
evaluate, based on the energy consumption control service criteria, at least one of:
access mobility and management policies,
session management policies, or
user equipment (UE) route selection policy (URSP) rules.
